(19) United States
(12) Patent Application Publication
(10) Pub. No.: US 2025/0013471 A1
(43) Pub. Date: Jan. 9, 2025

(54) PROFILING CIRCUITRY

(71) Applicants: Norwegian University of Science and Technology (NTNU), Trondheim (NO); Universiteit Gent, Gent (BE)

(72) Inventors: Magnus Jahre, Trondheim (NO); Björn Gottschall, Trondheim (NO); Lieven Eeckhout, Evergem (BE)

(21) Appl. No.: 18/694,318

(22) PCT Filed: Sep. 23, 2022
(86) PCT No.: PCT/EP2022/076574

§ 371 Date: Mar. 21, 2024

(30) Foreign Application Priority Data
Sep. 24, 2021 (GB) 2113678.3

(51) Int. Cl. G06F 9/38; G06F 9/30

(52) U.S. Cl. CPC G06F 9/3856; G06F 9/30098

(57) ABSTRACT

Profiling circuitry for a processor includes state-determining circuitry that is configured to access information stored by the processor for committing inflight instructions in program order, and to use this information to determine a commit state of the processor. The profiling circuitry also has sampling circuitry which is configured, when the processor is in a first commit state, to output sample data to a sample register or a memory that identifies one or more instructions that are next to be committed by the processor, and, when the processor is in a second commit state, to output sample data to the sample register or memory that identifies an instruction that was last committed by the processor.

### BACKGROUND OF THE INVENTION

This invention relates to profiling circuitry for profiling software execution on a processor.

It can be useful for software developers to be able to determine which parts of a program take the most time for a processor to execute. Instruction-level software profiling tools can allow a developer to determine this down to the level of individual processor instructions. To support such profiling, a processor may have associated profiling circuitry, comprising hardware logic for sampling a currently-executing instruction. Sampling at regular intervals, as a program executes, and counting how often each instruction appears in the collected sample data, it can be statistically determined how much time the processor is spending executing each instruction.

However, modern processors typically execute program instructions out of program order and with instruction-level parallelism (i.e. superscalar), making it difficult to collect meaningful statistics. A processor that supports out-of-order instruction execution, e.g. according to a Tomasulo algorithm, typically has a reorder buffer for tracking the state of all inflight instructions, as instructions need to be committed in program order to provide precise exceptions. The modifications that an instruction makes to the architectural state maintained by the processor becomes visible to software when the instruction is committed.

Embodiments of the present invention seek to provide profiling circuitry that supports more accurate profiling on processors, including, but not limited to, processors that execute instructions out of program order.

### SUMMARY OF THE INVENTION

From a first aspect, the invention provides profiling circuitry for a processor, wherein the profiling circuitry comprises:
state-determining circuitry configured to access information stored by the processor for committing inflight instructions in program order, and to use said information to determine a commit state of the processor; and
sampling circuitry configured, when the processor is in a first commit state, to output sample data to a sample register or a memory that identifies one or more instructions that are next to be committed by the processor, and, when the processor is in a second commit state, to output sample data to the sample register or memory that identifies an instruction that was last committed by the processor.

From a further aspect, the invention provides a processing system comprising:
a processor; and
profiling circuitry,
   wherein the processor is configured to store information for committing inflight instructions in program order, and
   wherein the profiling circuitry comprises:
state-determining circuitry configured to use said information to determine a commit state of the processor; and
sampling circuitry configured, when the processor is in a first commit state, to output sample data to a sample register or a memory that identifies one or more instructions that are next to be committed by the processor, and, when the processor is in a second commit state, to output sample data to the sample register or memory that identifies an instruction that was last committed by the processor.

From a further aspect, the invention provides a method for instruction-level profiling comprising:
determining a commit state of a processor from information stored by the processor for committing inflight instructions in program order; and
when the processor is in a first commit state, writing sample data to a sample register or a memory that identifies one or more instructions that are next to be committed by the processor, and, when the processor is in a second commit state, writing sample data to the sample register or memory that identifies an instruction that was last committed by the processor.

Thus it will be seen that, in accordance with embodiments of the invention, the instruction that was most recently committed (referred to herein as “last-committed instruction” or “LCI”) can be sampled, in addition to the one or more instructions that are next to be committed. This contrasts with naïve approaches in which only the next-committing instruction (referred to herein as “next-committing instruction” or “NCI”)—e.g. the instruction that is at the head of a reorder buffer at each sample point—is sampled, or in which only the last-committed instruction is sampled. By being able to sample both the next-committing instruction(s) and the last-committed instruction, profiling circuitry can enable more accurate profiles to be created of software executed on the processor, as explained in greater detail below. In particular, it can allow more accurate indications of which instructions are consuming the most processing time.

The processor may support execution of instructions out of program order. However, this is not essential and, in other embodiments, the processor is configured always to execute instructions in program order.

The processor may be a scalar or superscalar processor.

The information stored (and used) by the processor for committing inflight instructions in program order may be stored in commit-information circuitry, which may be a reorder buffer (e.g. in embodiments in which the processor supports execution of instructions out of program order), or a scoreboard (e.g. in embodiments in which the processor always executes instructions in program order), or other appropriate circuitry such as hazard detection logic (e.g. in embodiments in which the processor has a five-stage pipelined architecture).

The state-determining circuitry is preferably configured to determine when a reorder buffer or pipeline of the processor has been flushed (e.g. due to a branch misprediction or to handle an exception). It may be configured to determine this from a state of the reorder buffer or pipeline—e.g. from one or more flush bits associated with each reorder buffer entry. This approach is compatible with existing processors, since even processors that flush wrong-path instructions immediately upon discovering that a branch is mispredicted typically include a flush bit in the reorder buffer to implement instructions that always flush (e.g. fence instructions).

The state-determining circuitry may be configured to determine which of the following four states the processor is in: computing, stalled, drained or flushed. It may be configured to signal the state to the sampling circuitry and/or to include state data encoding the state in the sample data.

The first commit state may be or include that a reorder buffer or pipeline of the processor contains one or more instructions (e.g. with the processor actively computing or stalled). It may be or include that a reorder buffer or pipeline of the processor has drained (e.g. due to an instruction cache miss or an instruction Translation Lookaside Buffer (TLB) miss). The first commit state may be or include both of these situations—i.e. when a reorder buffer or pipeline contains one or more instructions or has drained. However, the first commit state preferably excludes the reorder buffer or pipeline being in a flushed state. Thus, the first commit state may comprise the computing state, the stalled state and the drained state.

The second commit state may be that the reorder buffer or pipeline has been flushed (e.g. due to a branch misprediction or an exception). Thus, the second commit state may be the flushed state. By identifying the last-committed instruction in such a situation, the sample data identifies the instruction that caused the misprediction (i.e. the branch instruction that was mispredicted), thus allowing a statistical profile to more accurately assign clock cycles to the instructions that are the cause of processing delays. This may be useful for accurate profiling not just on out-or-order processors, but also on in-order processors, as it can allow profiling software to take account of the fact that some in-order processors sometimes flush the pipeline in response to an instruction being committed.

The sampling circuitry may be configuring to output successive sample data at output instants separated by output intervals. Respective sample data may thus be associated with respective output instants, which may correspond to different respective processor clock cycles. The output intervals may be regular intervals or may be irregular (e.g. pseudorandom) intervals. In some embodiments, the sampling circuitry may output sample data (e.g. to a sample register) at every processor clock cycle, although it may output the sample data less often than this. In such embodiments, software (e.g. profiling software executing on the processor or a further processor) or other circuitry (e.g. a performance management unit (PMU)) may read all or a fraction of the sample data; for example, it may fetch, at regular or irregular collection intervals, the latest sample data stored in the sample register or memory.

In some embodiments, the sampling circuitry may be configured, when the processor is in the first commit state, to output sample data that does not identify the last-committed instruction (i.e. that only identifies the one or more or all instructions that are next to be committed by the processor). It may be configured, when the processor is in a second commit state, to output sample data that does not identify any next-committing instruction (i.e. that only identifies the instruction that was last committed by the processor).

However, in other embodiments, the sampling circuitry may be configured to output sample data, associated with a common output instant or processor clock cycle, that identifies one or more instructions that are next to be committed by the processor and that also identifies an instruction that was last committed by the processor. In this case, profiling software may use state data output by the state-determining circuitry to discard instructions that are not relevant and to attribute a sample count only to one or more NCIs or only to the LCI, depending on the state data.

The state-determining circuitry may be configured to output state data to the sample register or memory that is representative of the commit state of the processor. In this way, a performance monitoring unit (PMU) and/or profiling software may subsequently determine the commit state of the processor by examining the output state data, associated with any given output event. Profiling software may use the state data to determine whether to count only one next-committing instruction (e.g. only the oldest such instruction), or every next-committing instruction, or the last-committed instruction, identified in the sample data associated with the output event, when generating a statistical profile across a plurality output events. However, in other embodiments, profiling software may only receive identification of either the NCI(s) or LCI (but not both), at each output event, depending on the processor commit state.

In some preferred embodiments, the sampling circuitry is configured—at least in some situations, such as when the processor is in a computing state (e.g. not stalled) and will commit a plurality of instructions at the next commit cycle—to identify a plurality of instructions that are next to be committed by the processor in the next commit cycle (i.e. in a common processor clock cycle). The sample data may identify all of said plurality of next-committing instructions. The sample data may identify every next-committing instruction for the common clock cycle.

This contrasts with a naïve approach in which only at most a single instruction, from the head of a reorder buffer, is identified, with any other instructions that will be committed simultaneously (i.e. by a superscalar processor) not being counted. This can lead to a biased profile resulting in inaccurate insights into which instructions are consuming most clock cycles. By identifying multiple next-committing instructions, embodiments can enable profiling software to generate more accurate profiles using the output data, e.g. by assigning an equal fractional clock-cycle count to each next-committing instruction, at least when the processor is in a computing state.

Thus, in some embodiments, the sampling circuitry is configured, when the processor is in a computing state (or in a drained state, for some embodiments) and will commit a plurality of instructions in the next commit cycle, to output sample data to the sample register or memory that identifies said plurality of instructions that are to be committed by the processor in the next commit cycle. This enables profiling software to assign count values to each of these instructions. In particular, profiling software may assign positive sample counts to all of the NCIs when in the computing state. While it could also do so for the drained state, in preferred embodiments, profiling software attributes a sample count only to the single oldest (i.e. first-committing) instruction when there is the plurality of NCIs. When the processor is in a computing state or drained state and has only a single instruction to commit next, the sampling circuitry may output sample data identifying said next-committing instruction.

The sampling circuitry may further be configured, when the processor is in a stalled state, to output sample data to the sample register or memory that identifies a single instruction that is next to be committed by the processor. The enables profiling software to assign a count value just to this one instruction. At least when stalled, this may be the oldest instruction in the reorder buffer or pipeline—i.e. the instruction at the head of the reorder buffer or pipeline. (In some embodiments, in which the processor comprises a plurality of reorder buffer banks, the sampling data may identify a plurality of instructions, e.g. one instruction from each bank, but then additionally comprising data indicating which one of these instructions is the oldest instruction.) In the drained state, it is possible the next-committing instruction might not yet be in the reorder buffer or pipeline.

In such embodiments, the sampling circuitry will be configured, when the processor is in a flushed state, to output sample data to the sample register or memory that identifies an instruction that was last committed by the processor.

Some embodiments may advantageously implement the sometimes idea of identifying a plurality of NCIs without necessarily also being configured to identify last-committed instructions when in a second state.

Thus, from another aspect, the invention provides profiling circuitry for a processor, wherein the profiling system comprises sampling circuitry configured to identify a plurality of instructions that are to be committed by the processor in a common processor clock cycle, and to output sample data to a sample register or a memory that identifies all of the plurality of instructions.

From a further aspect, the invention provides a processing system comprising:
a processor; and
profiling circuitry,
   wherein the profiling circuitry comprises sampling circuitry configured to identify a plurality of instructions that are to be committed by the processor in a common processor clock cycle, and to output sample data to a sample register or a memory that identifies all of the plurality of instructions.

From a further aspect, the invention provides a method for instruction-level profiling comprising identifying a plurality of instructions that are to be committed by a processor in a common processor clock cycle, and writing sample data to a sample register or a memory that identifies all of the plurality of instructions.

Any features of embodiments embodying the preceding aspects may be features of embodiments of these aspects also, and vice versa. The sampling circuitry may be configured to identify such a plurality of next-committing instructions whenever the processor is in a computing state and will commit a plurality of instructions at the next commit cycle.

The sampling circuitry may be configured to write sample data to the sample register or memory (i.e. to generate a sample) in response to an internal event timer within the sampling circuitry, but in a preferred set of embodiments it is configured to do so in response to receiving a command from outside the sampling circuitry—e.g. from a PMU.

In some embodiments of any of the aspects disclosed herein, the sampling circuitry may output the sample data directly to a volatile or non-volatile memory (e.g. RAM) at every output instant. The processing system may comprise a memory (e.g. RAM), to which the sampling circuitry may write the sample data. However, in other embodiments, the profiling circuitry comprises a sample register (i.e. comprising a plurality of flip-flops), to which the sampling circuitry outputs the sample data (at least initially) at every output instant. The sample register may be sized for storing data identifying a plurality of instructions—e.g. for storing a plurality of instruction memory addresses. It may be sized for storing data identifying a plurality of next-committing instructions. It may be sized for storing data identifying at least one next-committing instruction and a last-committed instruction. It may be sized for storing data identifying at least as many instructions as the commit width of the processor. The sample register or memory may be implemented in any appropriate way, and may be split across multiple distinct regions or locations.

The profiling circuitry (or the processing system more widely) may comprise a performance monitoring unit (PMU), which may be arranged to collect some or all of the sample data from the sample register at regular or irregular sampling intervals. It may write the collected sample data to a volatile or non-volatile memory (e.g. RAM or hard-drive). The sampling intervals may correspond to a sampling rate that is lower than an output rate at which the profiling circuitry updates the sample register. Alternatively, the profiling circuitry may be controlled to output the sample data to the sample register at the same rate as the PMU collects the sample data. The sampling circuitry may be configured to inform the PMU that new sample data has been written to the sample register. The PMU may be configured to trigger an interrupt of the processor after collecting the sample data. The interrupt may invoke an interrupt handler in profiling software stored in a memory of the processing system.

More generally, the processing system may comprise a memory storing profiling software comprising instructions for processing at least some of the sample data to generate an instruction-level profile of software executed by the processor. The profiling software may be executed by the same processor (although it could be executed by a different processor of the processing system in some embodiments).

The profiling software may comprise instructions for analysing a software application executed by the processor. The profiling software may comprise instructions for determining count values for instructions of the software. It may comprise instructions to increment a count value for an instruction when that instruction is identified as a next-committing instruction and the processor is in the first commit state. It may comprise instructions to increment count values for one or more instructions by equal amounts (e.g. equal fractional amounts when there are a plurality of instructions) when the instructions are identified as next-committing instructions for a common clock cycle and the processor is in a computing state. However, it may comprise instructions to increment a count value of only an oldest of a plurality of next-committing instructions for a common clock cycle when the processor is in a stalled state. Similarly, it may comprise instructions to increment a count value of only an oldest of a plurality of next-committing instructions for a common clock cycle when the processor is in a drained state. It may comprise instructions to increment a count value for an instruction when that instruction is identified as the last-committed instruction and the processor is in the second commit state.

The sampling circuitry may be configured to output sample data that identifies which is an oldest of a plurality of next-committing instructions identified in the sample data. This may be used for accurately allocating clock cycles when the processor is in a stalled state. The processor may have a reorder buffer comprising a plurality of banks (e.g. if the processor is a Berkeley Out-of-Order Machine processor), and the sampling circuitry may be configured to access a pointer to the head bank and a pointer to the head column and to use these pointers to determine the oldest next-committing instruction.

The sampling circuitry may be configured to output sample data that identifies which is a youngest of a plurality of next-committing instructions identified in the sample data. This may be used for accurately allocating clock cycles when the reorder buffer or pipeline is in a flushed state. It may store the address of the youngest such instruction in a register (e.g. an “offending-instruction register”), which it may update on every processor clock cycle, and may copy the address from the offending-instruction register to the sample register or memory, e.g. in response to detecting there is no valid instruction at the head of the reorder buffer and/or that the processor is in the flushed state.

The sample data may identify instructions in any appropriate way. It may comprise an address of each identified instruction.

The sampling circuitry may be configured to exclude from the sample data any invalid next-committing instruction (e.g. any instruction identified as not valid in the reorder buffer). Alternatively, it may be configured to output sample data that identifies all next-committing instructions (i.e. valid and invalid) and that also identifies which of the next-committing instructions are valid (e.g. by setting a respective binary “validity” flag in the sample register, associated with each respective next-committing instruction).

The sampling circuitry may be configured to output a stalled signal, for a processor clock cycle, (e.g. as part of the sample data) if the reorder buffer or pipeline contains one or more instructions, but no instructions are being committed in the clock cycle.

The sampling circuitry may be configured to output a flushed signal, for a processor clock cycle, (e.g. as part of the sample data) if an instruction has triggered a flush of the reorder buffer or pipeline.

The processor and profiling circuitry may, in some embodiments, be implemented as a semiconductor integrated circuit, e.g. on a silicon chip.

Features of any aspect or embodiment described herein may, wherever appropriate, be applied to any other aspect or embodiment described herein. Where reference is made to different embodiments or sets of embodiments, it should be understood that these are not necessarily distinct but may overlap.

### BRIEF DESCRIPTION OF THE DRAWINGS

Certain preferred embodiments of the invention will now be described, by way of example only, with reference to the accompanying drawings, in which:

FIG. 1 is a pair of graphs showing instruction-level profile errors for various naïve profiling approaches and for a profiler embodying the invention (TIP);

FIG. 2 is a set of schematic diagrams of the operation of an out-of-order processing system and showing various sample point locations used by different profiling approaches;

FIG. 3 is a flow chart of clock-cycle attribution using an exhaustive profiling approach (Oracle) that is useful for understanding a principle of operation of embodiments of the invention;

FIG. 4 is a set of four diagrams showing exemplary reorder buffer (ROB) content over time and corresponding collected sample-count statistics under three different profiling sample strategies, for each of four different processor and reorder buffer (ROB) states;

FIG. 5 is a schematic diagram of an integrated-circuit processor chip comprising a Time-Proportional Instruction Profiler (TIP) embodying the invention;

FIG. 6 is a schematic diagram of the sample selection logic of the TIP;

FIG. 7 is a graph of normalized cycle stacks collected at commit for a variety of benchmark operations;

FIG. 8 is a graph of functional-level errors for various naïve profiling approaches (Software, Dispatch, LCI, NCI) and for two profilers embodying the invention (TIP, TIP-ILP), for a variety of benchmark operations, under different reorder buffer conditions;

FIG. 9 is a graph of basic-block-level errors for LCI, NCI, TIP and TIP-ILP, for a variety of benchmark operations, under different reorder buffer conditions;

FIG. 10 is a graph of instruction-level errors for NCI, TIP and TIP-ILP, for a variety of benchmark operations, under different reorder buffer conditions;

FIG. 11 is a set of graphs comparing the sensitivity of NCI, TIP and TIP-ILP with respect to (a) sampling rate, (b) sampling method, and (c) commit-parallelism;

FIG. 12 is a diagram of function- and instruction-level profiles for the Imagick benchmark, for NCI, TIP and Oracle; and

FIG. 13 is a time breakdown for the four most runtime-intensive functions in Imagick, comparing a first embodiment (“original”) to a second embodiment (“optimized”).

### DETAILED DESCRIPTION

Various example embodiments are described in detail below, and experimental results are provided which demonstrate the effectiveness of the disclosed approaches.

First, some background and context is provided, to help the reader better understand the embodiments and some of the advantages they provide over other approaches.

### 1. Introduction

Software developers can use tools that automatically attribute processor execution time to source code constructs, such as instructions, basic blocks, and functions, in order to improve the efficiency of the software they write.

Software profilers generate performance profiles for software applications. A performance profile statistically attributes processor execution time to different application-level symbols. Depending on the use case, developers can select symbols at different granularities, including: functions, basic blocks, and individual instructions.

Gathering profiles without hardware support is inherently inaccurate. We refer to this herein as a “Software” approach. Software-level profilers (e.g. Linux perf, operating in a default configuration) interrupt the application and retrieve the address of the instruction that execution will resume from after the interrupt has been handled. Hence the current inflight instructions will drain before the interrupt handler is executed which means that the sampled instruction can be tens or even hundreds of instructions away from the instruction(s) that the processor was committing at the time the sample was taken. This phenomenon is known as “skid” and can be addressed by adding hardware support for instruction sampling. Known hardware-based profiling circuitry includes Intel™ PEBS, AMD™ IBS, and Arm™ SPE.

Hardware-supported profiling enables sampling in-flight instructions without interrupting the application and hence eliminates skid by effectively removing the latency from sampling decision to sample collection. Hardware profilers rely on sampling, which involves collecting and logging instruction addresses at regular time intervals. The theory is that the number of sample counts assigned to a particular instruction over a profiling period indicates how much time the processor spent executing that instruction. However, modern processors implement speculative processing in which instructions are executed out-of-order, which can reduce the accuracy of known profiling approaches.

Although all hardware profilers use such sampling, they differ in their policies for selecting which instruction to attribute a sample point to, at each sample interval.

A first approach, used by Intel's Processor Event-Based Sampling (PEBS), is to return the address of the next instruction that commits after the sample is taken. We will refer to this herein as a “next-committing instruction (NCI)” heuristic.

A second approach, used by profilers that use debug interfaces, such as Arm CoreSight, is to systematically sample the last-committed instruction. We refer to this herein as a “last-committed instruction (LCI)” heuristic.

A third approach, used by AMD's Instruction-Based Sampling (IBS) and Arm's Statistical Profiling Extension (SPE), is first to tag an instruction at dispatch and then to retrieve the sample when the instruction commits. Unlike the commit-focused approaches, this enable gathering data about how this instruction flows through the processor back-end. We refer to this as a “Dispatch” heuristic.

However, none of these heuristics is accurate under all situations.

In order to analyse the effectiveness of different approaches, we present a “golden reference” profiler, which we refer to herein as the “Oracle” profiler. Although this profiler embodies aspects of the invention, and is possible to implement on a device, it is not expected to be used widely in practice, due to the huge amount of data it processes: rather than using a statistical sampling approach, the Oracle profiler samples every single instruction as it is committed by a processor. A fundamental principle behind the Oracle profiler is the recognition that an accurate profiler must perform time-proportional attribution, i.e. with every clock cycle being attributed to the particular instruction or instructions whose latency is exposed by the processor. The Oracle profiler focuses on the processor's commit stage, because this is where the latency cost of each instruction is resolved and becomes visible to software. More specifically, the best-case instruction latency in a processor that can commit w instructions per cycle is 1/w cycles-meaning that the processor has been able to hide all of the instruction latency except for 1/w cycles. If the processor is unable to fully hide an instruction's execution latency, the instruction will stall at the head of the reorder buffer (ROB) and thereby block forward progress; i.e. the time commit blocks is the instruction's contribution to the application's execution time.

The Oracle profiler provides a benchmark for establishing the accuracy of naïve hardware performance profiling approaches. Section 4, below, provides details of an experimental setup and error metric that can be used for such benchmarking.

However, the Oracle profiler is not a practicable approach for everyday use, due to the very large volume of data that it outputs. We therefore present below a sampling-based profiler, which we call the “Time-Proportional Instruction Profiler (TIP)”, that also implements a principle of focusing on the commit stage of an associated processor, but which also uses periodic sampling, rather than collecting comprehensive data as the Oracle approach does, in order to generate a manageable amount of statistical data for analysis.

### Time-Proportional Instruction Profiler (TIP)

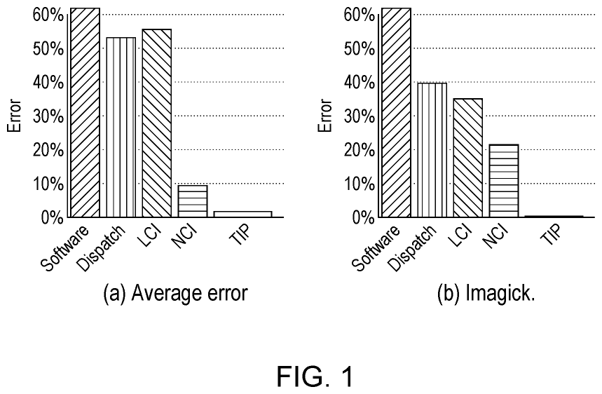

TIP combines the time-attribution policies of Oracle with statistical sampling, thereby reducing the amount of profiling data by several orders of magnitude compared to Oracle (e.g. generating sample data at a rate of 192 KB/s versus 179 GB/s for the Oracle profiler, at a 4 KHz sampling frequency). The use of sampling has the potential to introduce statistical error; however, we have determined that the amount of error introduced in practice is often negligible, as shown by FIG. 1.

The two graphs in FIG. 1 compare instruction-level profile errors, determined using an experimental setup described below, across the naïve approaches of “Software”, “Dispatch”, “LCI” and “NCI” and the novel “TIP” approach that embodies aspects disclosed herein. The first graph (FIG. 1a) shows average profiling error across the twenty-seven SPEC CPU2017 and PARSEC 3.0 benchmarks we used in our experimental evaluation (detailed below), while the second graph (FIG. 1b) shows profile error for the SPEC CPU2017 benchmark Imagick, which performs various prescribed transforms on input images. (Section 4, below, describes our experimental setup, benchmarks, and the profile error metric in detail.) Both graphs show that statistical error is negligible in practice under the tested conditions. More specifically, as shown in FIG. 1a, the average instruction-level profile error of TIP is merely 1.6%—hence TIP reduces average error by factors of 5.8, 34.6, 33.2, and 38.6 compared to NCI, LCI, Dispatch, and Software profiling, respectively. We implemented TIP in the Berkeley Out-of-Order Machine (BOOM) within the FireSim simulation infrastructure. FireSim is developed by the Berkeley Architecture Research Group and is an open-source cycle-accurate FPGA-accelerated full-system hardware simulation platform that runs on cloud FPGAs.

While low profile error is attractive, a primary benefit of accurate performance profiling comes from helping developers write more efficient software applications. To illustrate that TIP's accuracy matters in practice, we used TIP and NCI to analyze the SPEC CPU2017 benchmark Imagick. Although both TIP and NCI are accurate at the function-level (0.3% and 0.6% average error, respectively), the function-level profile does not clearly identify the performance problem; this is a challenge with function-level profiles as developers use functions to organize functionality rather than performance. At the instruction-level, TIP correctly attributed time to Control and Status Register (CSR) instructions that cause pipeline flushes whereas NCI misattributed execution time to the next-committing instruction (see Section 6 for details). Interestingly, Imagick does not need to execute the CSR instructions, and replacing them with nop instructions yielded a 1.93 times speed-up compared to the original, mostly due to the second-order effect that removing flushes improves the processor's ability to hide latencies.

### 2. Time-Proportional Profiling

Practical performance profilers rely on statistical sampling to create a profile, i.e. they randomly retrieve the address of a currently executing instruction. Embodiments disclosed herein rely on the realisation that, since sampling is random in time, in order to get accurate sampling, the probability of sampling an instruction—and time hence being attributed to it—should be proportional to the instruction's impact on overall execution time. We refer to this principle as time-proportional attribution. Consider for example a processor that executes a single instruction at a time: an instruction that takes two clock cycles to execute should be attributed twice as much time as a single-cycle instruction.

Understanding why sampling at the commit stage enables time-proportional attribution requires going into some detail on how an out-of-order processor operates. Out-of-order processors consist of an in-order front-end that fetches and decodes instructions, predicts branches, performs register renaming, and finally dispatches instructions to the reorder buffer (ROB) and to the issue queues of the appropriate execution unit. Then, instructions are executed as soon as their inputs are available (possibly out-of-order). Instructions are typically committed in program order to support precise exceptions, and the ROB is used to track instruction order.

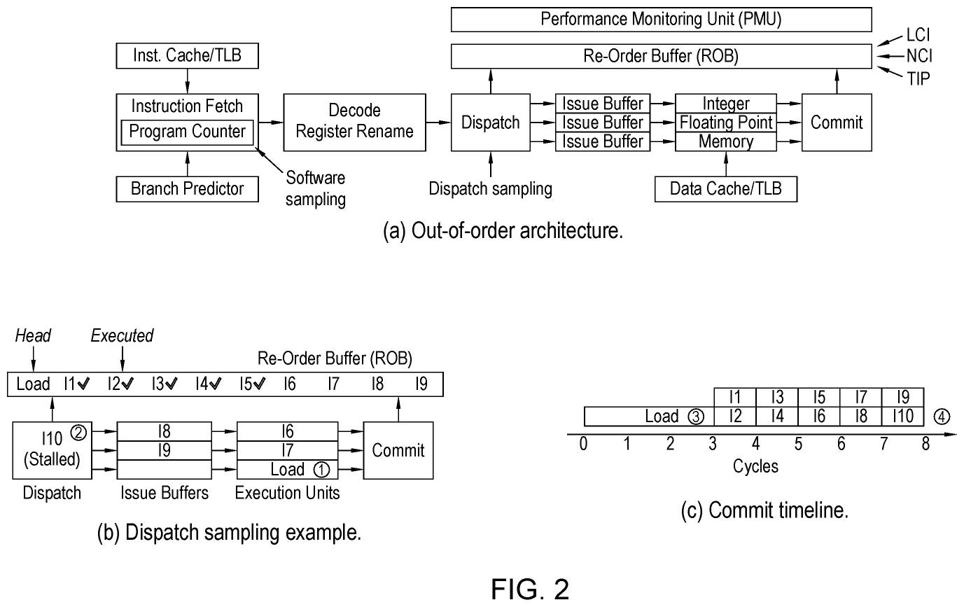

FIG. 2a illustrates the architecture of a generic out-of-order processing system. It is labelled to indicate that software-based profiling samples at the Instruction Fetch stage; dispatch-based sampling acts at the Dispatch stage; and LCI, NCI and TIP policies are applied at the re-order buffer (ROB).

Sampling at commit enables time-proportional attribution because this is where an instruction's execution becomes visible to software, and significantly is also where its latency impact on overall execution time becomes visible. Sampling at commit is a necessary but not sufficient condition for achieving time-proportional attribution because the profiler must also attribute time to the instruction that the processor spends time on. For example, the time spent resolving a mispredicted branch must be attributed to the branch and not some other instruction. We find that none of the naïve profiling approaches we considered do time-proportional attribution. In particular, Dispatch and Software do not sample at commit, while NCI and LCI misattribute time. Section 2.1 exemplifies why not sampling at commit is inaccurate, while Section 2.2 explains why the Oracle profiler (and hence the TIP profiler which is derived from it) does time-proportional attribution, and why NCI and LCI do not.

### 2.1. Dispatch and Software Profiling

Dispatch sampling selects the instruction to be profiled at the dispatch stage and then tracks it through the processor back-end. While this provides interesting insight regarding how an individual instruction progresses through the pipeline, it is not time-proportional. FIG. 2b shows an example of the state of a processor that is currently stalling on a “load” instruction (see label “1” in FIG. 2b). Since the processor has a number of independent instructions to process (I1, I2, . . . ), it is able to execute these instructions while the load is pending. However, this leads to the ROB filling up with instructions which in turn stalls dispatch (see label “2”). This results in instruction I10 getting stuck at dispatch due to the back-pressure created by the load instruction. I10 will hence attract samples under the Dispatch sampling policy as it spends more time in the dispatch stage than other instructions. FIG. 2c shows the situation in FIG. 2b from the perspective of the commit stage. If we sample at commit, the load instruction will attract samples as it spends more time at the head of the ROB than the other instructions (see label “3”). Sampling at commit hence enables time-proportional attribution, i.e. the load instruction is sampled more frequently because the processor spends more time executing it. In contrast to the Dispatch approach, when sampling at commit the processor only exposes a half-clock-cycle latency for I10 (i.e. one cycle allocated between instructions I9 and I10) because its execution latency is almost completely hidden (see label “4”).

Software profiling is also not time-proportional due to a phenomenon referred to as skid. As with Dispatch, long-latency instructions lead to commit stalls that attract samples, but, unlike Dispatch, Software attributes time to instructions that are fetched around the time the sample is taken. The reason is that Software relies on interrupts. Upon an interrupt, the processor stores the application's current Program Counter (PC) and transfers control to the interrupt handler which then attributes the sample to the instruction address in the PC. Software hence tends to attribute latency to instructions that are even further away from the stalled instruction in the instruction stream than Dispatch.

### 2.2. Oracle Profiling

In this section, we present Oracle, which is time-proportional by design, i.e. it attributes each clock cycle during program execution to the instruction(s) which the processor exposed the latency of in this cycle. While NCI and LCI both sample at commit, they employ different instruction selection policies. More specifically, NCI samples the next-committing instruction, whereas LCI samples the last-committed instruction, and we will now explain why neither policy is time-proportional.

### Oracle Overview

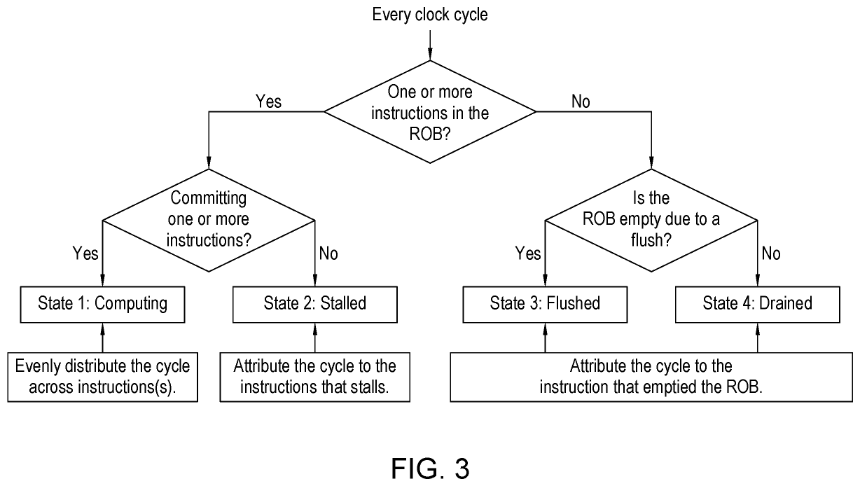

Oracle leverages the fundamental insight that the commit stage is in one of four possible states in each clock cycle, which we refer to herein as: Computing, Stalled, Flushed, or Drained. As shown in FIG. 3, every clock cycle, the Oracle first checks if the ROB contains instructions (i.e. it is not empty). If the ROB is not empty, the Oracle profiler checks if the processor is committing one or more instructions in this cycle. If so, the processor is determined to be in the Computing state (State 1 in FIG. 3), and the Oracle attributes 1/n clock cycles to each of the n committing instructions. If the processor is not committing instructions and there are instructions in the ROB, it is determined to be in the Stalled state (State 2 in FIG. 3). In this case, there is an instruction at the head of the ROB but it cannot be committed as it has not yet fully executed. The Oracle hence attributes the cycle to the instruction at the head of the ROB as it is blocking commit. If the ROB is empty, Oracle attributes the clock cycle to the instruction that cleared the ROB. If the ROB is empty due to misspeculation, the processor is determined to be in the Flushed state (State 3 in FIG. 3). More specifically, the processor is in the flushed state if it committed all non-speculative in-flight instructions before the ROB could be refilled. In this case, the Oracle attributes the cycle to the instruction that caused the flush (e.g. a mispredicted branch). The ROB can also be empty because the front-end is not supplying instructions, typically due to an instruction cache miss or instruction Translation Lookaside Buffer (TLB) miss. In this case, the processor is determined to be in the Drained state (State 4 in FIG. 3), and the Oracle attributes the cycle to the first instruction that enters the ROB after the stall, as this is the instruction that delayed the front-end (i.e. that caused the ROB to empty).

### Comparing Oracle Against NCI and LCI

We now explain Oracle in more detail for the four fundamental states and compare against NCI and LCI to explain in which cases NCI and LCI do or do not misattribute clock cycles.

### State 1: Computing

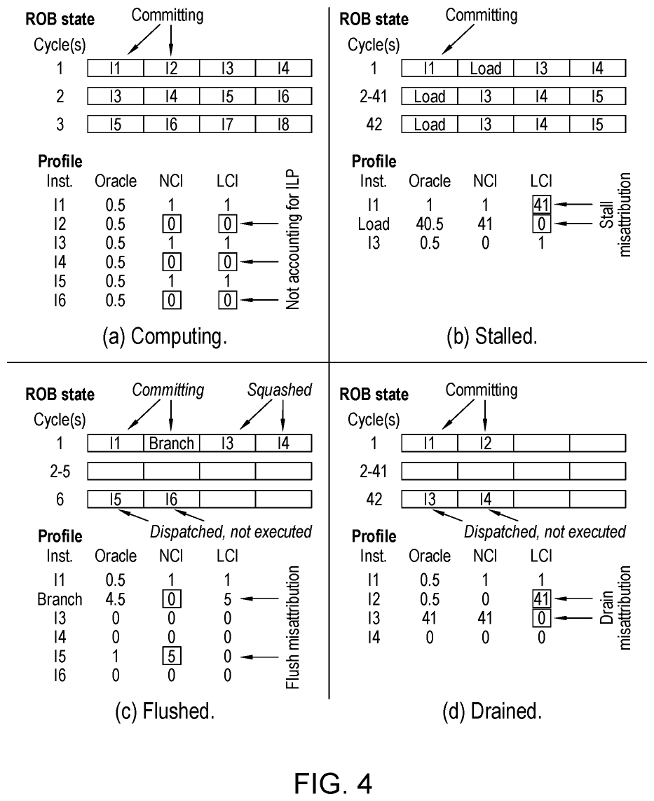

In the computing state, Oracle accounts 1/n cycles to each committed instruction where n is the number of instructions committed in that cycle (i.e. n is a number between 1 and the processor's commit width). FIG. 4a illustrates this behavior by showing the four oldest ROB-entries of a processor with 2-wide commit. In cycle 1, instructions I1 and I2 are committing and Oracle hence accounts 0.5 cycles to each. In contrast, NCI and LCI select a single instruction to attribute the clock cycle to. This is undesirable as it overly attributes cycles to some instructions while missing others-possibly to the extent that certain instructions are executed but not represented in the profile. Oracle, on the other hand, accounts for every clock cycle and every dynamic instruction.

Not acknowledging instruction-level parallelism (ILP) within the commit stage renders the NCI and LCI profiles difficult to interpret. The key reason is that many applications execute similar instruction sequences over and over. Since NCI and LCI select instructions to sample with a fixed policy, they will be biased towards selecting certain instructions at the expense of others. It is hence difficult for developers to ascertain if a latency difference between instructions in straight-line code segments is due to a performance issue (e.g. some instructions stalling more than others) or attribution bias.

### State 2: Stalled

FIG. 4b illustrates how Oracle, NCI, and LCI handle pipeline stalls that occur when instructions reach the head of the ROB before they have been executed. In this example, I1 is committed in cycle 1 before commit stalls for 40 cycles on the load instruction from cycle 2 to 41; a 40-cycle latency is consistent with a partially hidden Last-Level Cache (LLC) hit in our setup. Oracle attributes the 40 cycles where the processor is stalled to the oldest instruction in the ROB since this is the instruction that the processor is stalling on, before attributing 0.5 cycles to the load and 0.5 cycles to I3 when they both commit in cycle 42. NCI agrees with Oracle with the exception of missing I3 in cycle 42 because it does not handle ILP. LCI, on the other hand, completely misattributes the load stall as I1 is the last-committed instruction from cycle 1 to cycle 41, i.e. LCI attributes 41 cycles to I1 and only a single cycle to the load (when it commits in cycle 42).

### State 3: Flushed

Pipeline flushes occur when the processor has speculatively fetched (and possibly executed) instructions that should not be committed. FIG. 4c illustrates how Oracle handles this case for a mispredicted branch. Some cycles before the example starts, the branch instruction was executed, and the processor discovered that the branch was mispredicted. The processor hence squashed all speculative instructions (e.g. I3 and I4). In cycle 1, I1 and the branch are committed, and Oracle attributes 0.5 cycles to each instruction. In parallel, the front-end fetches instructions along the correct path which ultimately leads to instructions being dispatched in cycle 6; branch mispredicts lead to the ROB being empty for 3.5 cycles on average in our setup. Oracle hence attributes the 4 cycles the ROB is empty to the branch instruction and 1 cycle to I5 (since the processor is stalling on it in cycle 6). LCI correctly attributes the stall cycles to the mispredicted branch whereas NCI does not. More specifically, NCI attributes the empty ROB cycles to I5 as it will be the next instruction to commit. Moreover, it attributes zero cycles to the branch instruction since it is committed in parallel with I1. It will undoubtedly be challenging for a developer to understand that an instruction that appears to not take any time is in fact responsible for the ROB being empty.

While the above attribution policy is sufficient to handle other misspeculation cases such as load-store ordering (i.e. a younger load was executed before an older store to the same address), flushes due to exceptions are handled differently. More specifically, an exception fires when the excepting instruction reaches the head of the ROB which in turn results in the pipeline being flushed and control transferred to the OS exception handler. When the exception has been handled (e.g. the missing page has been installed in the page table), the excepting instruction is re-executed. Hence, Oracle attributes the cycles where the ROB is empty due to an exception to the instruction that caused the exception. Once the instructions of the exception handler are dispatched, the Oracle attributes cycles to these instructions (i.e. the Oracle does not differentiate between application and system code).

### State 4: Drained

The ROB drains when the processor runs out of instructions to execute, for instance due to an instruction cache miss. This situation differs from pipeline flushes in that all instructions to be drained from the ROB are on the correct path and hence will be executed and committed. FIG. 4d exemplifies this situation. In cycle 1, I1 and I2 are committed. This leaves the ROB empty until cycle 42. The culprit is that the processor missed, in the instruction cache, when fetching I3, and that the latency of retrieving the cache block and resuming execution was only partially hidden by executing previously fetched instructions. Oracle hence attributes 0.5 cycles to each of I1 and I2 since they both commit in cycle 1. It also attributes forty-one cycles to I3; forty cycles is due to the drain and one cycle is attributed because I3 is stalled at the head of the ROB in cycle 42. Similar to the stalled case, NCI is mostly correct since I3 is the next instruction to commit when the instruction cache miss is resolved. In contrast, LCI misattributes the empty ROB cycles to I2.

### Sequential States

We have so far discussed the four fundamental states of the commit stage as if they are independent states. However, instructions often accumulate cycles across multiple states. For example, within the example of FIG. 4c, instruction I5 moves from the Flushed state to the Stalled state, and the processor will be in the Computing state when I5 eventually commits. The same applies to I3 from Drained to Stalled (FIG. 4d). This observation is critical to understand how Oracle handles more complex situations, and we now describe how the four states are sufficient for serialized instructions (e.g. fences and atomic instructions) and page misses.

Serialized instructions require that (i) all prior instructions have fully executed before they are dispatched, and (ii) that no other instructions are dispatched until they have committed. While the ROB drains, Oracle will account time to the preceding instructions according to the time they spend at the head of the ROB. When the last preceding instruction commits, the serialized instruction is dispatched and hence immediately becomes the oldest in-flight instruction. Oracle hence accounts time to this instruction as Stalled while it executes and as Computing the cycle it commits. Once it has committed, the subsequent instruction is dispatched and Oracle will account it as Stalled while it executes.

Another example is a page miss on a load instruction. In this case, the load accesses the data TLB and L1 data cache in parallel. This results in a TLB miss which invokes the hardware page table walker. Eventually, the page table walker concludes that the requested page is not in memory which causes the exception bit to be set in the load's ROB-entry. If the load reaches the head of the ROB before the page table walk completes, the Oracle starts accounting time as stalled. When the page table walk completes, the load is marked as executed and the exception is triggered once it reaches the head of the ROB. The cycles from the exception to dispatching the first instruction in the OS exception handler are attributed to the load. Once the OS has handled the exception by installing the missing page in memory, the load is re-executed. The load will then incur more stall cycles as it waits at the ROB head for its page mapping to be installed in the TLB and its data to be fetched from memory.

### 3. TIP: Time-Proportional and Practical Profiling

We now build upon the cycle-level attribution insights of Oracle to describe a practical and accurate Time-Proportional Instruction Profiler (TIP). The profiler can be implemented as hardware circuitry associated with a processor, which may be largely of conventional design. The profiler circuitry and the processor may, in some embodiments, be integrated on a single semiconductor chip.

### 3.1. Implementing TIP

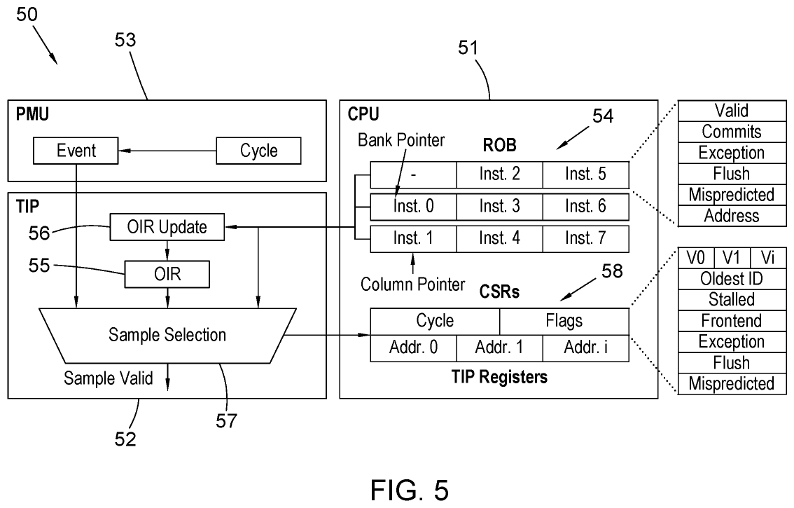

FIG. 5 shows a processing system 50 (e.g. forming part of an integrated circuit) comprising a processor (CPU) 51 which may be largely of conventional design (apart from the CSRs 58), a profiler (TIP) 52 embodying the invention, and a Performance Monitoring Unit (PMU) 53 that may be of substantially conventional design. The TIP 52 is located between the PMU 53 and the reorder buffer (ROB) 54 of the CPU 51. Although the PMU is described here as distinct from the profiling circuitry, it may be regarded as part of the profiling circuitry in some embodiments. We now describe in detail how TIP 52 captures samples, as well as how profiling software such as Linux perf can retrieve TIP's samples at runtime so that, once the application terminates, the profiling software can post-process the samples to create a performance profile.

### Sample Collection

Some exemplary embodiments use a CPU 51 comprising a Berkeley Out-of-Order Machine (BOOM) core. This includes a ROB 54, containing b banks. Up to one instruction per bank can be committed in each clock cycle (i.e. b is the commit width). Instructions are allocated to banks in the order of the bank identifiers. The instruction in bank i is hence always older than the instruction in bank i+1 within a column, but the b oldest ROB-entries may be distributed across two columns, as shown in FIG. 5. Identifying the head of the ROB hence requires a pointer to the head bank and another pointer to the head column. The core can commit b instructions each cycle since the b oldest instructions will always be allocated in different banks. Similarly, b ROB-entries can be allocated concurrently at dispatch as long as b entries are available between the tail pointers and the current head pointers. When there are no invalid entries between the tail and head pointers, the ROB is full and dispatch stalls until one or more instructions commit. While the exact ROB realization may differ between architectures, it should fundamentally allow b-wide reads (which TIP exploits). TIP 52 comprises an Offending Instruction Register (OIR) 55 and two functional units (comprising logic circuitry): an OIR Update unit 56 and a Sample Selection unit 57. These two functional units 56, 57 collectively both embody state-determining circuitry and sampling circuitry, as disclosed herein, distributed between them. The decision to take a sample is triggered by a cycle counter located in the PMU 53, which then causes the sampling circuitry to output sample data to the PMU 53 for analysis. The CPU 51 includes a TIP-specific set of Control and Status Registers (CSRs) 58 which are accessed by TIP 52. Although these are shown as being within the CPU boundary in FIG. 5, they are distinct from the CPU's conventional CSR registers and could equally be regarded as part of the TIP 52 itself. The CSRs 58 collectively embody a sample register, as disclosed herein. Hence, the TIP 52, CSRs 58 and optionally the PMU 53 may be regarded as providing profiling circuitry as disclosed herein.

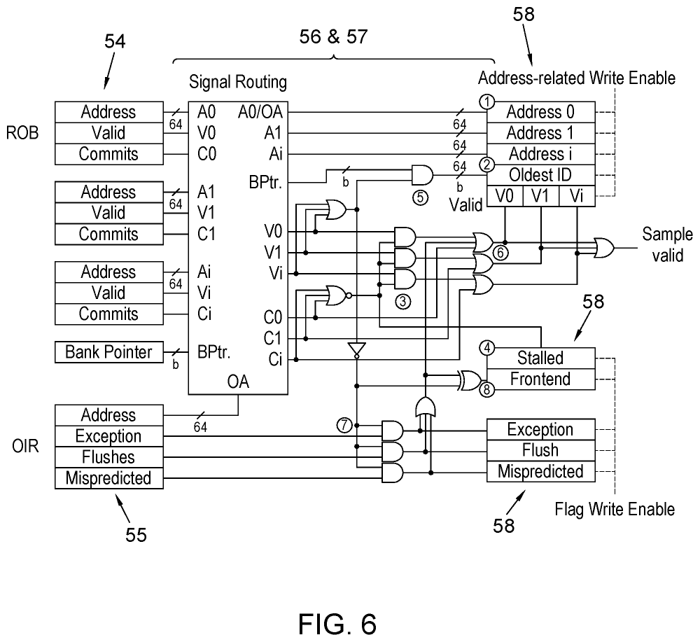

FIG. 6 provides additional details of aspects of the ROB 54, OIR 55, the TIP functional unit 56, 58, and the CSRs 58. In particular, it shows more detail of the logic within the Sample Selection unit 57.

When the ROB 54 is not empty, TIP 52 simply copies the addresses of the head ROB-entries into its address registers (see label “1” in FIG. 6). Architectures commonly divide instructions into one or more micro-operations (μOps); in such implementations, TIP exploits processor tracking of the Op-to-instruction mapping to handle interrupts and exceptions. To enable identifying the oldest ROB-entry, TIP stores the ROB bank pointer in an Oldest ID register (see label “2”). Address valid bits (V0, V1, . . . . Vi) are selected from the commit and valid signals (see label “3”) in the Computing state and Stall state, respectively (see FIG. 3). During post-processing, these states are identified by inspecting TIP's Stalled flag in the CSRs 58 which is “1” when no instructions are committed (see label “4”). If the Stalled bit is “0”, the core is in the Computing state, and the sample will be attributed to all valid address CSRs (divided in equal shares of one cycle). Conversely, the sample will be attributed to the address identified by the Oldest ID flag if the Stalled flag is “1”. TIP only needs to record that the core stalled on this particular instruction since the stall type can be identified by inspecting the instruction type in the binary during post-processing.

If the processor is neither committing nor stalling, the ROB is empty due to a flush or a drain. TIP's OIR Update unit 56 continuously tracks the last-committed and last-excepting instruction from the ROB 54, as shown in FIG. 5. More specifically, TIP updates the OIR 55 with the address and relevant ROB-flags of the youngest committing ROB-entry every cycle; the relevant flags record if the instruction is a mispredicted branch or triggered a pipeline flush. It can detect a mispredicted branch or pipeline flush from a bit, in the ROB entry of the instruction, that is set when the CPU 51 needs to flush the pipeline; TIP copies this bit to the “Flushes” flag in the OIR 55 (see FIG. 6) for the youngest committing ROB-entry during OIR update. If the processor is not committing instructions, TIP checks if the core is about to trigger an exception. If it is, TIP writes the address of the excepting instruction and an exception flag into the OIR 55. As can be seen from FIG. 6, when all head ROB-entries are invalid, TIP (i) places the OIR address in the Address 0 CSR, (ii) sets the oldest ID to “0” (see AND gate at label “5”), (iii) sets V0 to “1” and remaining “valid” bits to “0” (see label “6”), and (iv) sets the Exception, Flush, or Mispredicted TIP-flags based on the OIR-flags (see label “7”). If one of these flags is set, the core is in the Flushed state.

If the ROB is not empty due to a flush, it must have drained (see FIG. 3). TIP hence immediately sets the Frontend flag as (i) the ROB is empty, and (ii) none of the Exception, Flush, or Mispredicted flags are set (see label “8”). TIP then deasserts the write enable signal of the flags to prevent further updates, but keeps the write enable signal of the address-related CSRs and flags asserted. When the first instruction (eventually) dispatches, its ROB-entry becomes valid and TIP copies this address into the address CSR corresponding to the ROB-bank the entry is dispatched to (and sets the Oldest ID and valid bits accordingly). TIP then deasserts the address-related write enable signal to prevent further updates.

### Creating an Application Profile

We have designed TIP to interface cleanly with Linux perf. When using hardware support for profiling, perf configures the PMU 53 to collect samples at a certain frequency (4 KHz is the default), and TIP issues an interrupt when the sampling procedure has completed and a valid sample has been written to the CSRs 58. This interrupt invokes perf's interrupt handler which simply copies the profiler's CSRs 58 into a memory buffer; the profile is written to non-volatile storage when the buffer is full. At the end of application execution, perf has written the raw samples to a file which then needs to be post-processed. To build the profile, the profiling software may use a data structure in which a zero-initialized counter is assigned to each unique instruction address in the profile. For each sample, it may then add 1/n of the value in the cycles register to each instruction's counter when the sample contains n instructions. It also tracks the total number of cycles to enable normalizing the profile.

However, in other embodiments, some or all of these operations (e.g. copying the CSRs 58 into a memory buffer) could be implemented in hardware, by the TIP circuitry, rather than being implemented in software.

To help developers understand why some instructions take longer than others, the software portion of TIP may combine the information provided by the status flags with analysis of the application binary. It may label cycles where the application is committing one or more instructions as execution cycles, and cycles where the ROB has drained as front-end cycles. If the processor 51 is stalled, TIP may use the application binary to determine the instruction type and to indicate if the oldest instruction is an ALU-instruction, a load, or a store. Moreover, it may differentiate between flushes due to branch mispredicts and miscellaneous flushes based on TIP's status flags. (It may group the miscellaneous flushes as they typically only account for a small fraction of application execution time on average.)

While this categorization is suitable for some purposes, such as those described below, it will be appreciated that TIP can be adapted to support more fine-grained categories if necessary.

### 3.2. TIP Overhead Analysis

### Hardware Overhead

TIP is extremely lean as it can mostly rely on functionality that is already present in a conventional ROB or PMU. The storage overhead of TIP is the OIR register 55 (64-bit address and a 3-bit flag) and the CSRs 58 (i.e. cycle, flags, and b address CSRs); we merge all TIP flags into a single CSR 58. In an exemplary implementation, all CSRs are 64-bit since RISCV's CSR instructions operate on the full architectural bit width, resulting in an overall storage overhead of fifty-seven bytes for our 4-wide BOOM core (nine bytes for the OIR and forty-eight bytes for the six CSRs). The logic complexity for collecting the samples is also minimal; the main overhead is two multiplexors, one to select the youngest ROB-entry in the OIR Update unit 56 and one to choose between the OIR 55 and the address in ROB-bank 0 in the Sample Selection unit 57. TIP's logic is not on the critical path of the BOOM core. If appropriate, the logic can be pipelined.

### Sampling Overhead

In some embodiments, TIP interrupts the core when a new sample is ready. Another possible approach is for TIP to write samples to a buffer in memory and then interrupt the core once the buffer is full. This requires more hardware support (i.e. inserting memory requests and managing the memory buffer), but reduces the number of interrupts. However, the interrupts become longer (as more data needs to be copied), so the total time spent copying samples is similar.

For each sample, perf reads the operating-system (OS) kernel structures to determine key metadata including core, process, and thread identifiers which account for forty bytes per sample in total. For our 4-wide BOOM core, the non-ILP-aware profilers (e.g. NCI) capture a single instruction address and the cycle counter (an additional 16 bytes) whereas TIP captures four instruction addresses, the cycle counter, and the flags CSR (an additional forty-eight bytes). At perf's default 4 KHz sampling frequency, TIP hence generates data at 352 KB/s whereas the data rate of the non-ILP-aware profilers is 224 KB/s.

To quantify the performance overhead of TIP, we compared PEBS' default sample size (i.e. fifty-six bytes per sample) to a configuration with TIP-sized samples on an Intel Core i7-4770. We mimicked TIP by including additional general-purpose registers from the PEBS record to reach TIP's eighty-eight byte sample size. We found that the increased data rate of TIP adds negligible overhead. More specifically, it increased application runtime by 1.1% compared to a configuration with profiling disabled; the performance overhead with PEBS' default sample size was 1.0%.

### Multi-Threading

Although we have so far described TIP in the context of single-threaded applications, this is not a fundamental limitation. More specifically, perf adds the core, process, and thread identifiers to each sample; the core identifier maps to a logical core under Simultaneous Multithreading (SMT). Apart from this, TIP will attribute time to one or more instructions as in the single-threaded case. For example, if a physical core is committing instruction I1 on logical core C1 and instruction I2 on logical core C2 in the same cycle, TIP attributes half of the time to I1 and half to I2. Each physical core needs its own TIP unit.

### 4. Experimental Setup

### Simulator

We used the FireSim cycle-accurate FPGA-accelerated full-system simulator to evaluate the different performance profiling strategies. The simulated model used the BOOM 4-way superscalar out-of-order core, configured as in the table below, which ran a common buildroot 5.7.0 Linux kernel.

| Part | Configuration |
|---|---|
| Core | OoO BOOM: RV64IMAFDCSUX @ 3.2 GHZ |
| Front- | 8-wide fetch, 32-entry fetch buffer, 4-wide decode, 28 KB TAGE |
| end | branch predictor, 40-entry fetch target queue, max 20 outstanding |
| | branches |
| Execute | 128-entry ROB, 128 int/fp physical registers, 24-entry dual-issue |
| | MEM queue, 40-entry 4-issue INT queue, 32-entry dual-issue |
| | FP queue |
| LSU | 32-entry load/store queue |
| L1 | 32 KB 8-way I-cache, 32 KB 8-way D-cache w/8 MSHRs, next- |
| | line prefetcher from L2 |
| L2/LLC | 512 KB 8-way L2 w/12 MSHRs, 4 MB 8-way LLC w/8 MSHRs |
| TLB | Page Table Walker, 32-entry fully-assoc L1 D-TLB, 32-entry |
| | fully-assoc L1 I-TLB, 512-entry direct-mapped L2 TLB |
| Memory | 16 GB DDR3 FR-FCFS quad-rank, 25.6 GB/s maximum |
| | bandwidth, 14-14-14 (CAS-RCD-RP) latencies @ 1 GHZ, 8 |
| | queue depth, 32 max reads/writes |
| OS | Buildroot, Linux 5.7.0 |

The BOOM core was synthesized to and run on the FPGAs in Amazon's EC2 F1 nodes. We accounted for the frequency difference between the FPGA-realization of the BOOM core and the FPGA's memory system using FireSim's token mechanism. We enabled the hardware profilers when the system boots and profiled until the system shuts down after the benchmark has terminated. However, we only included the samples that hit application code in our profiles, as (i) the time our benchmarks spend in OS code (e.g. syscalls) is limited (1.1% on average), and (ii) we do not want to include boot and shutdown time in the profiles.

We modified FireSim to trace out the instruction address and the valid, commit, exception, flush, and mispredicted flags of the head ROB-entry in each ROB bank every cycle; the trace includes the ROB's head and tail pointers which we need to model Dispatch. We feed this trace to a highly parallel framework on the CPU-side to enable on-the-fly processing with only minimal simulation slowdown. The profilers are hence modeled on the CPUs that operate in lock-step with the FPGA by processing the traces. This allows us to simulate and evaluate multiple profiler configurations out-of-band in a single simulation run; we run up to nineteen profiler configurations on eight CPUs per FPGA simulation run. For the results described herein, the total time spent on Amazon EC2 amounted to 5,459 FPGA hours and 30,778 CPU hours. We evaluated multiple profilers with a single simulation run because (i) it enables fairly comparing profilers as they sample in the exact same cycle, and (ii) it reduces the evaluation time (and cost) on Amazon EC2.

### Benchmarks

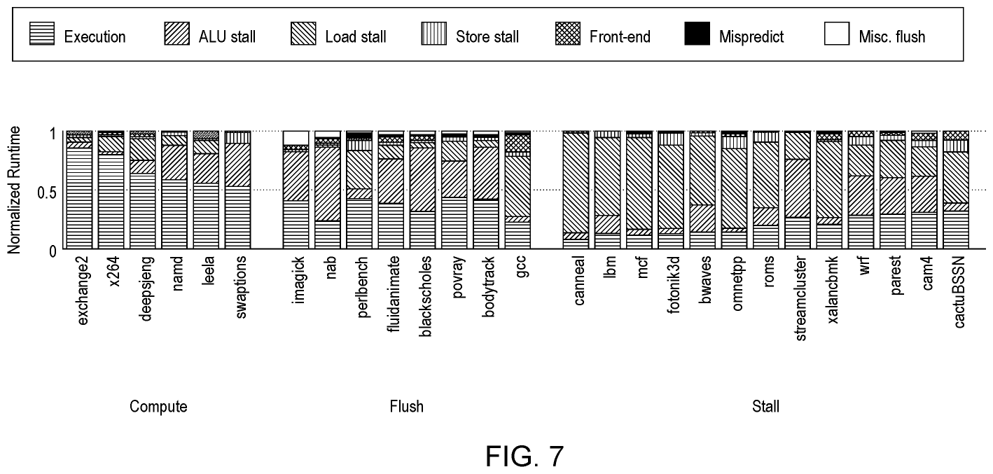

We ran twenty-seven SPEC CPU2017 and PARSEC 3.0 benchmarks that are compatible with our setup, the names of which are listed along the horizontal axis of FIG. 7. (We use x264 from PARSEC). We simulated the benchmarks to completion using the reference inputs for CPU2017 and the native inputs for PARSEC; we ran single-threaded versions of PARSEC. We compiled all benchmarks using GCC 10.1 with the −O3-g compilation flags and static linking.

The benchmarks' execution characteristics are shown in FIG. 7 which reports normalized cycle stacks captured at commit, i.e. we attribute every cycle to a specific type, and we then represent the cycle types as a stacked bar with the execute component shown at the bottom, followed by the other cycle types on top; we introduced the categories in Section 3.1 above. We use the cycle stacks to classify our benchmarks: (i) a benchmark is classified as Compute-Intensive if it spends more than 50% of its execution time committing instructions; (ii) if not, and if the benchmark spends more than 3% of its time on pipeline flushing, the benchmark is classified as Flush-Intensive; and (iii) the rest of the benchmarks are classified as Stall-Intensive as they spend a major fraction of their execution time on processor stalls.

### Quantifying Profile Error

Practical sampling profilers incur inaccuracies compared to the (impracticable) exhaustive Oracle approach since they rely on statistical sampling and hence record a small percentage of instruction addresses, which are then attributed to symbols in the application binary; the symbols are individual instructions, basic blocks or functions, depending on profile granularity. There are two fundamental sources of error.

Unsystematic errors occur because sampling is random and the distribution of sampled symbols does not exactly match the distribution obtained with Oracle. Unsystematic errors can be reduced by increasing sampling rate, as we will quantify in the evaluation. Systematic errors, on the other hand, occur because the profiling strategy attributes samples to the wrong symbol. We focus on systematic error in the evaluation by quantifying to what extent the different profilers attribute samples to the correct symbol as determined by the Oracle. Because we sample the exact same cycle for all the practical profilers in a single simulation run, we can precisely quantify and compare a profiler's systematic error.

Each sample is taken as a representative for the entire time period since the last sample. By comparing the symbol the sample is attributed to by the practical profiler against the symbol identified by Oracle, we determined whether a sample is correctly or incorrectly attributed. By aggregating the cycles correctly attributed to symbols (i.e. c_{correct}) and relating this to the total number of cycles it takes to execute the application (i.e. cₜₒₜₐₗ), we can compute the relative error e (i.e. e=(cₜₒₜₐₗ−c_{correct})/cₜₒₜₐₗ). Error is a lower-is-better metric varying between 100% and 0%, where 100% means that all samples were incorrectly attributed, while 0% means that the practical profiler attributes each sample to the same symbol as Oracle. Profile error can be computed at any granularity, i.e. instruction, basic block, or function level; incorrect attribution at lower granularity can be correct at higher granularity (e.g. misattributing a sample to an instruction within the function that contains the correct instruction). We aggregated errors across benchmarks using the arithmetic mean.

### 5. Experimental Results

We compared the following profilers:
Software: generates an interrupt and samples the instruction after the interrupt (e.g. Linux perf).
Dispatch: tags an instruction at dispatch and samples when it commits.
Last Committed Instruction (LCI): selects the last-committed instruction.
Next Committing Instruction (NCI): selects the next-committing instruction.
ILP-Oblivious Time-Proportional Instruction Profiling (TIP ‘minus’ ILP, or TIP-ILP): follows TIP (see Section 3), but omits ILP accounting, i.e. when multiple instructions commit in the sampled cycle, the sample is attributed only to a single instruction (i.e. the instruction at the head of the ROB).
Time-Proportional Instruction Profiling (TIP): the profiler disclosed in Section 3.

We compared against Oracle which attributes every cycle to the symbol at the profiling granularity of interest, using the policy described in Section 2.2. As mentioned before, the error differences between the hardware profiling strategies (i.e. all profilers except Software) are due to systematic inaccuracies only as we sample in the exact same cycle. We assume periodic sampling at a typical sampling frequency of 4 KHz, unless mentioned otherwise. We explore the impact of periodic versus random sampling and the impact of sampling frequency in our sensitivity analyses.

### 5.1. Profile Error

### Function-Level Profiling

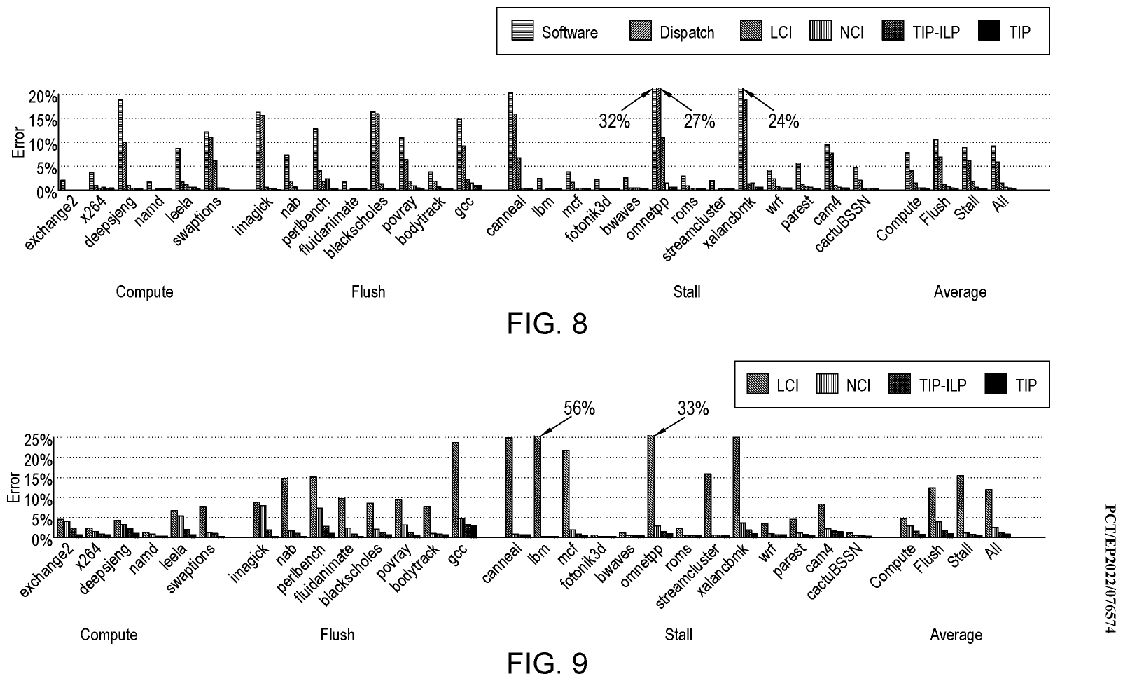

FIG. 8 reports error at the function level across all the profilers considered in this work. While TIP is the most accurate profiler (average error 0.3%), TIP-ILP, NCI, and LCI are also accurate with average errors of 0.4%, 0.6%, and 1.6%, respectively. (Note there are some outliers though for LCI up to 10.9%.) Software and Dispatch are much less accurate (9.1% and 5.8% average error, and up to 31.7% and 27.4%, respectively) because tagging instructions at fetch and dispatch creates significant bias. More specifically, samples are attracted to the instructions that are being fetched or dispatched while the processor is experiencing long-latency stalls. The overall conclusion is that all profilers, except Software and Dispatch, are accurate at function-level granularity. Since Software and Dispatch are inherently inaccurate, we will exclude them for the smaller profiling granularities to more clearly show the differences between the more accurate profilers. However, we will report their average errors in the text for completeness.

### Basic-Block-Level Profiling

Correctly attributing samples to functions does not necessarily mean that a performance analyst will be able to identify the most performance-critical basic blocks. We hence need to dive deeper and evaluate our profilers at the basic block level. FIG. 9 shows profile errors at the basic block level for all profiling strategies, except Software and Dispatch which are highly inaccurate (average error of 29.9% and 22.4%, respectively). TIP and TIP-ILP are most accurate with average errors of 0.7% and 1.2%, respectively. NCI is also reasonably accurate with an average error of 2.3%, whereas LCI is inaccurate at this level with an average error of 11.9% and up to 56.1%. The reason is that LCI incorrectly attributes stalls on long-latency instructions (e.g. LLC load misses) to the instruction that last committed before the stall. For example, load stalls and functional unit stalls dominate the runtime of Ibm (a Lattice Boltzmann Method benchmark) (66.2% and 15.6%, respectively). The performance-critical loop nest in Ibm also contains significant control flow which leads LCI to attribute samples to the wrong basic block, which results in an overall error of 56.1%. The overall conclusion is that TIP, TIP-ILP, and NCI are accurate at the basic block level, whereas Software, Dispatch, and LCI are not.

It is also interesting to note that the error is higher at the basic block level compared to the function level; and this is true for all profilers. The most striking example is Ibm: the LCI's function-level error is merely 0.3% and then increases to 56.1% at the basic block level. The reason is that a single function accounts for 99.7% of Ibm's total runtime, which means that an incorrect attribution at the basic block level most likely still leads to a correct attribution at the function level. This reinforces our claim that fine-granularity profiles are critical as knowing that 99.7% of runtime is spent in a (non-trivial) function is too high-level to clearly identify optimization opportunities.

### Instruction-Level Profiling

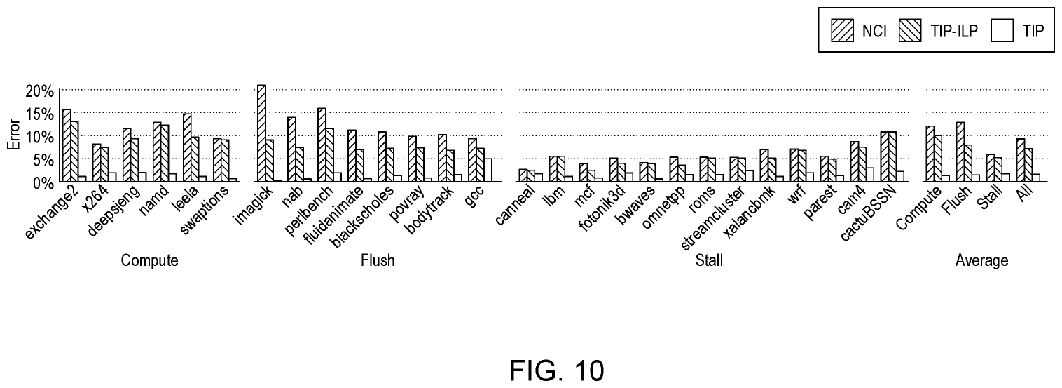

In order to effectively understand and mitigate bottlenecks, performance analysts need profiling information that is even more detailed than the basic block (and function) level, with performance stranglers identified at the instruction level. FIG. 10 reports instruction-level profile error for TIP, TIP-ILP, and NCI. Software, Dispatch, and LCI are not included here as they are largely inaccurate (i.e. average error of 61.8%, 53.1%, and 55.4%, respectively). The key conclusion is that TIP is the only accurate profiler at the instruction level. Indeed, the average profile error for TIP equals 1.6%, while the errors for TIP-ILP and NCI are significantly higher, namely 7.2% and 9.3%, respectively. Hence, TIP reduces average error by factors of 5.8, 34.6, 33.2, and 38.6 compared to NCI, LCI, Dispatch, and Software, respectively. We observe the highest error under TIP for gcc (5.0%), and find that the error can be reduced significantly by increasing the sampling frequency, as we will discuss later.

There are two reasons why TIP is the most accurate profiler. First, we observe a significant decrease in profile error when comparing NCI versus TIP-ILP for the flush-intensive benchmarks (see FIG. 10). The reason is TIP-ILP (and TIP) correctly attributes a sample that hits a branch misprediction or pipeline flush to the instruction that is responsible for refilling the pipeline, namely the mispredicted branch or the flush instruction, which is the instruction that was last committed. NCI on the other hand incorrectly attributes the sample to the instruction that will be committed next. Second, we observe the largest decrease in profile error between TIP-ILP and TIP for the compute-intensive benchmarks (see FIG. 10). The compute-intensive benchmarks commit multiple instructions per cycle, and hence attributing an equal share of the sample to all the committing instructions is the correct approach. TIP-ILP and NCI on the other hand attribute the sample to a single instruction which leads to a biased performance profile.

### 5.2 Sensitivity Analyses

We performed various sensitivity analyses with respect to sampling rate, sampling method, and commit-ILP accounting. We focused on instruction-level profiling and considered the most accurate profilers only, namely TIP, TIP-ILP, and NCI.

### Sampling Rate

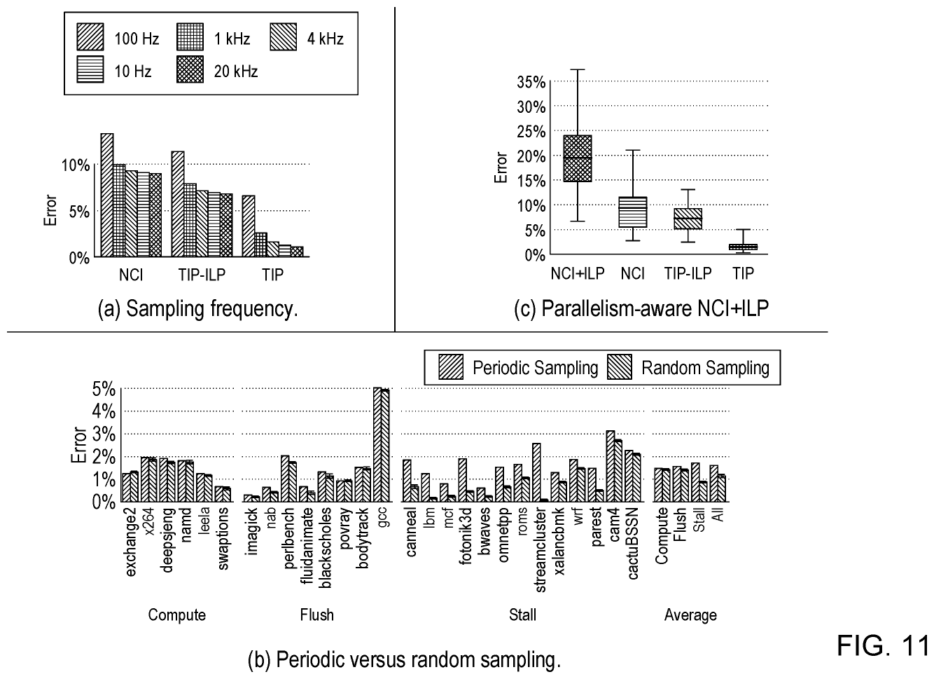

The default sampling rate was set to 4 KHz. We focused on unsystematic error by evaluating how profiling error varies with sampling frequency from 100 Hz to 20 KHz, as shown in FIG. 11a. As expected, profiling error decreased with increasing sampling frequency; and this was true for all profilers. Moreover, the reduction in error was more significant for the lower frequencies as these have more unsystematic error. The most interesting observation is that TIP's accuracy continues to measurably improve as the sampling frequency is increased beyond 4 KHz, while it saturates for the other profilers. The most notable example is gcc for which the error decreased from 5.0% at 4 KHz (see FIG. 10) to 2.6% at 20 KHz. Profiling continues to decrease with frequency under TIP because TIP, unlike TIP-ILP and NCI, attributes high-ILP commit cycles to multiple instructions.

### Sampling Method

The sampling method used so far assumes periodic sampling, i.e. we take a sample every 250 μs (sampling frequency of 4 KHz). Periodic sampling may lead to an unrepresentative profile if the sampling frequency aligns unfavorably with the application's time-varying execution behavior (cf. Shannon-Nyquist sampling theorem). Random sampling may alleviate this by selecting a random sample within each 250 μs sampling interval. FIG. 11b quantifies profile error for periodic versus random sampling. We find that the impact is small for most benchmarks, except for a handful stall-intensive benchmarks such as streamcluster, Ibm, and fotonik; these benchmarks exhibit repetitive time-varying execution behavior that is susceptible to sampling bias. On average, the error decreases from 1.6% under periodic sampling to 1.1% under random sampling. Because random sampling is more complicated to implement in hardware, periodic sampling may be preferred in some embodiments.

### Commit-Parallelism-Aware NCI

TIP is more accurate than NCI because it correctly accounts for pipeline flushes and commit parallelism. Our results show that the biggest contribution comes from correctly attributing commit parallelism, i.e. compare the decrease in average instruction-level profile error from 9.3% (NCI) to 7.2% (TIP-ILP) due to correctly attributing pipeline flushing, versus the decrease in profile error from 7.2% (TIP-ILP) to 1.6% (TIP) due to attributing commit parallelism. We considered whether accounting for commit parallelism in NCI would yield a level of accuracy that is similar to TIP, and we hence made NCI commit parallelism-aware by simply attributing 1/n of the sample to the n next-committing instructions.

FIG. 11c presents box plots of the instruction-level error for commit-parallelism-aware NCI, labelled NCI+ILP, versus TIP, TIP-ILP, and NCI. Surprisingly, the average profile error increases with NCI+ILP, from 9.3% (NCI) to 19.3% (NCI+ILP). The primary reason is that NCI+ILP incorrectly attributes a sample to the n next-committing instructions after a long-latency stall (e.g. LLC miss), instead of attributing the entire sample to the long-latency instruction as done by TIP. A key insight is that commit-parallelism attribution is most beneficial when sample attribution is done in a correct and principled way in the first place, as is the case for TIP.

### Validation

We used FireSim for our evaluation because the profilers considered in this work are platform-specific, hence it is impossible to compare the different profilers without re-implementing on a common platform. To evaluate our experimental setup, we conducted a validation experiment for the most accurate naïvely implemented profiler, namely NCI. Lacking an Oracle profiler on real hardware platforms, we had to compare the relative difference among existing profilers to gauge their accuracy. In particular, we compared Linux perf against PEBS on an Intel i-4770 system, versus our implementations of the Software profiler and NCI in FireSim, respectively. Obviously, one cannot expect a perfect match because we are comparing across instruction-set architectures (x86-64 versus RISC-V) and thus benchmark binaries. Yet, we still verified that the relative difference (computed using our error metric) between the respective profilers indeed fell within the same broad ranges across our set of benchmarks, both at the instruction level and function level. At the instruction level, the difference between PEBS and perf on Intel amounted to 69% on average versus 57% on FireSim when comparing NCI versus Software. At the function level, the difference equalled 4% versus 7%, respectively.

### 6. Profiling Case Study

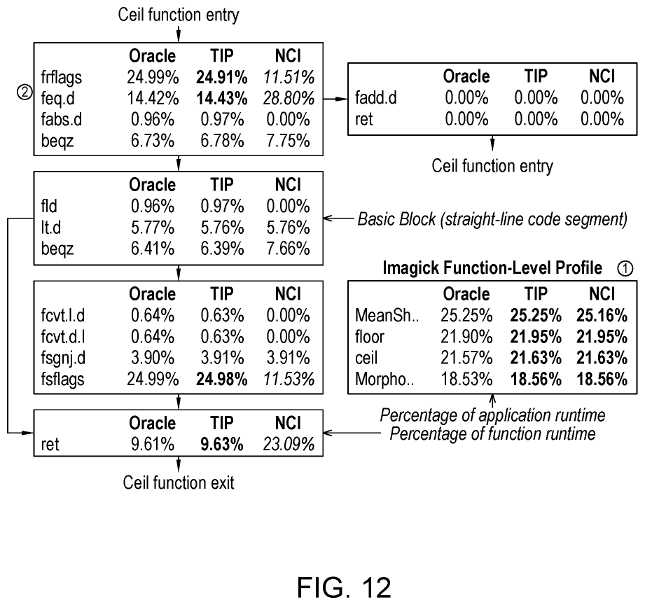

We performed a case study on the SPEC CPU2017 benchmark Imagick to illustrate how TIP pinpoints the root cause of performance issues. FIG. 12 shows the function- and instruction-level profiles of NCI, TIP, and Oracle for the ceil function in Imagick; ceil is a math library function and the third hottest function in Imagick. (We report the fraction of total runtime in the function-level profile, and the fraction of time within the function in the instruction-level profile.) The function-level profile does not clearly identify any performance problem (see label “1” in FIG. 12), suggesting to the developer that no further optimization is possible; a basic-block-level profile suffers from the same limitation. The instruction-level NCI profile attributes most of the execution time to the feq.d and the ret instructions (see labels “2” and “3”, respectively), likely leading to the conclusion that the floating point unit(s) are overloaded and that the return address predictor is ineffective. Hence, the developer will probably conclude that further software-level optimization is difficult.

TIP, on the other hand, correctly reported that most of the time in ceil is spent on the frflags and fsflags instructions, and the purpose of these instructions is to mask any changes to the floating-point status register that may occur within the function from the calling code. These instructions are hence necessary if the calling code relies on ceil being side-effect free. Interestingly, Imagick never reads the floating-point status register which means that the masking performed within ceil is unnecessary. Moreover, the floor function suffers from exactly the same problem. We optimized Imagick's binary code by replacing frflags and fsflags in ceil and floor with nop instructions to remove the unnecessary status register operations, hence creating a new, optimized version.

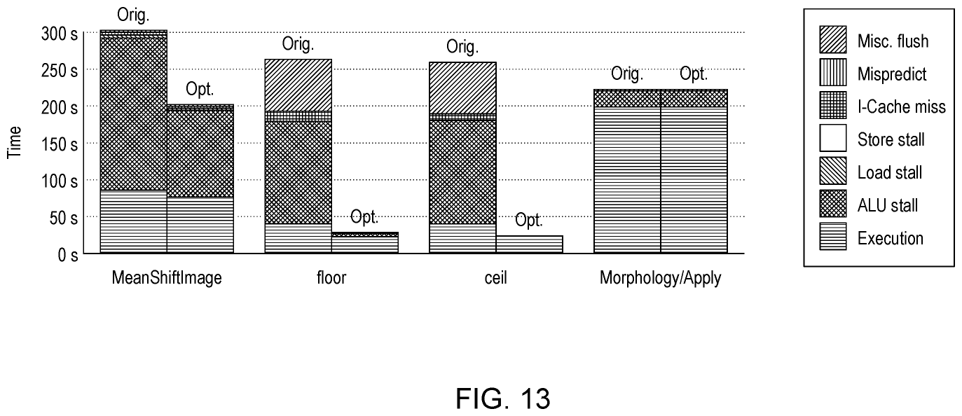

FIG. 13 presents a cycle stack that compares the original Imagick benchmark (marked “Orig.”) to our optimized version (marked “Opt.”) across the four hottest functions in the original version. As expected, the original benchmark spends significant time in the “Misc. flush” category because the BOOM core flushes the pipeline after floating-point status register updates to guarantee that instruction dependencies are respected (the BOOM core does not rename status registers) whereas our optimized version does not flush at all. Overall, our optimized version improves performance by a factor of 1.93 compared to the original version and hence clearly illustrates that TIP identifies optimization opportunities that matter.

Interestingly, the speedup is (much) higher than expected based on the fraction of time spent executing the frflags and fsflags instructions (see FIG. 12). More specifically, the instructions collectively account for about 50% of the execution time of two functions that each account for around 22% of overall execution time, yielding an expected speedup of 1.28 times. The reason is that the frequent pipeline flushing induced by the floating-point status register accesses has a detrimental effect on the processor's ability to hide latencies. For instance, both ceil and floor spend significant time on ALU stalls and front-end stalls—since the processor does not have sufficient instructions available to hide functional unit latencies and instruction cache misses. Moreover, our optimization improves IPC from 1.2 to 2.3 which leads to the processor spending less time executing instructions. The effects of improved IPC and reduced stalling carry over to the MeanShift Image function from which ceil and floor is called, reducing its execution time by roughly one third.

TIP can help developers understand how time is distributed across instructions, by precisely attributing time to individual instructions. It can potentially also help support additional performance analysis such as vertical profiling (which combines hardware performance counters with software instrumentation to profile an application across deep software stacks); call-context profiling (which efficiently identifies the common orders functions are called in); and causal profiling (which is able to identify the criticality of program segments in parallel codes by artificially slowing down segments and measuring their impact).

TIP can be straightforwardly implemented by integrating some additional circuitry with an out-of-order core. It is therefore useful for practical implementation, in contrast to purely simulation- and modelling-based approaches such as FirePerf (which uses FireSim to non-intrusively gather extensive performance statistics), which generate too much data to be practicably implementable outside a simulator.

We have presented our Oracle profiler, as a novel golden reference for performance profiling, and used it to show that naïve profiler approaches fall short because they are not time-proportional, as they lack support for instruction-level parallelism, and systematically misattribute instruction latencies. We have described a Time-Proportional Instruction Profiler (TIP) which combines the attribution policies of Oracle with statistical sampling to enable practical implementation. Experimental data shows TIP is highly accurate (e.g. having an average instruction-level error of 1.6%), and can be used to improve software, as evidenced by having been used to identify a performance issue in the SPEC CPU2017 benchmark Imagick that, once addressed, yielded a 1.93-factor speed-up.

It will be appreciated by those skilled in the art that the invention has been illustrated by describing various specific embodiments thereof, but is not limited to these embodiments; many variations and modifications are possible, within the scope of the accompanying claims.

1. Profiling circuitry for a processor, wherein the profiling circuitry comprises:
state-determining circuitry configured to access information stored by the processor for committing inflight instructions in program order, and to use said information to determine a commit state of the processor; and
sampling circuitry configured, when the processor is in a first commit state, to output sample data to a sample register or a memory that identifies one or more instructions that are next to be committed by the processor, and, when the processor is in a second commit state, to output sample data to the sample register or memory that identifies an instruction that was last committed by the processor.

2. The profiling circuitry of claim 1, wherein the state-determining circuitry is configured to determine when the reorder buffer or pipeline of the processor has been flushed, and wherein the second commit state is a flushed state in which the reorder buffer or pipeline has been flushed.

3. The profiling circuitry of claim 1, wherein the first commit state is that a reorder buffer or pipeline of the processor contains one or more instructions or is drained.

4. The profiling circuitry of claim 1, wherein the state-determining circuitry is configured to determine which of a computing state, a stalled state, a drained state and a flushed state the processor is in, and to output state data to the sample register or memory that is representative of the determined state.

5. The profiling circuitry of claim 1, wherein the sampling circuitry is configured, when the processor is in a computing state and will commit a plurality of instructions at a next commit cycle, to output sample data to the sample register or memory that identifies every instruction that is to be committed by the processor in the next commit cycle.

6. The profiling circuitry of claim 1, wherein the sampling circuitry is configured, when the processor is in a stalled state, to output sample data to the sample register or memory that identifies a single instruction that is next to be committed by the processor.

7. (canceled)

8. The profiling circuitry of claim 1, wherein the sampling circuitry is configured to output successive sample data at output intervals, wherein respective sample data corresponds to different respective processor clock cycles.

9. The profiling circuitry of claim 1, comprising a sample register sized for storing data identifying a plurality of instructions.

10. The profiling circuitry of claim 1, comprising a sample register sized for storing data identifying at least as many instructions as a commit width of the processor.

11. The profiling circuitry of claim 1, wherein the sampling circuitry is configured to output sample data that identifies which is an oldest of a plurality of next-committing instructions identified in the sample data.

12. The profiling circuitry of claim 1, wherein the sampling circuitry is configured to output sample data that identifies which is a youngest of a plurality of next-committing instructions identified in the sample data.

13. The profiling circuitry of claim 1, wherein the sampling circuitry is configured to output sample data that identifies which instruction or instructions of a plurality of next-committing instructions identified in the sample data was or were identified as valid in a reorder buffer of the processor.

14. The profiling circuitry of claim 1, wherein the sampling circuitry is configured to output a stalled signal, for a processor clock cycle, if a reorder buffer or pipeline of the processor contains one or more instructions and no instructions are being committed in the processor clock cycle, and to output a flushed signal, for a processor clock cycle, if an instruction has triggered a flush of the reorder buffer or pipeline.

15. A processing system comprising:
a processor, configured to store information for committing inflight instructions in program order; and
the profiling circuitry of claim 1.

16. The processing system of claim 15, wherein the profiling circuitry comprises a sample register to which the sampling circuitry is arranged to output the sample data, and further comprises a performance monitoring unit arranged to collect some or all of the sample data from the sample register, at regular or irregular sampling intervals, and to write the collected sample data to a volatile or non-volatile memory of the processing system.

17. The processing system of claim 15, comprising a memory storing profiling software comprising instructions for processing at least some of the sample data to generate an instruction-level profile of a software application executed by the processor, wherein the profiling software comprise instructions for determining count values for instructions of the software application by incrementing count values for one or more instructions by equal amounts when the one or more instructions are identified as next-committing instructions for a common clock cycle and the processor is identified as having been in a computing state, and by incrementing a count value for only an oldest of a plurality of next-committing instructions for a common clock cycle when the processor is identified as having been in a stalled state or a drained state, and by incrementing a count value for an instruction when that instruction is identified as the last-committed instruction and the processor is identified as having been in a flushed state.

18. The processing system of claim 15, wherein the processor is an out-of-order processor comprising a reorder buffer, and is configured to store the information for committing inflight instructions in program order in the reorder buffer.

19. A method for instruction-level profiling comprising:
determining a commit state of a processor from information stored by the processor for committing inflight instructions in program order; and
when the processor is in a first commit state, writing sample data to a sample register or a memory that identifies one or more instructions that are next to be committed by the processor, and, when the processor is in a second commit state, writing sample data to the sample register or memory that identifies an instruction that was last committed by the processor.

20. (canceled)

21. Profiling circuitry for a processor, wherein the profiling system comprises sampling circuitry configured to identify a plurality of instructions that are to be committed by the processor in a common processor clock cycle, and to output sample data to a sample register or a memory that identifies all of the plurality of instructions.

22. A processing system comprising:
a processor, configured to store information for committing inflight instructions in program order; and
the profiling circuitry of claim 21.
